(19) United States
(12) Patent Application Publication
(10) Pub. No.: US 2008/0311463 A1
(43) Pub. Date: Dec. 18, 2008

(54) MEMBRANE ELECTRODE ASSEMBLY WITH MULTILAYERED CATHODE ELECTRODE FOR USING IN FUEL CELL SYSTEM

(75) Inventors: Jun-Young PARK, Suwon-si (KR); Seung-shik Shin, Suwon-si (KR); Mee-young Lee, Suwon-si (KR); Tae-keun Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/130,420

(22) Filed: May 30, 2008

(30) Foreign Application Priority Data
Jun. 13, 2007 (KR) 10-2007-0057902

(51) Int. Cl. H01M 4/96

(52) U.S. Cl. 429/41

(57) ABSTRACT

A membrane electrode assembly in a fuel cell system includes a cathode electrode that includes a support layer; a catalyst layer; and a first carbon layer and second carbon layer between the support layer and the catalyst layer, the first carbon layer having a relatively higher porosity and the second carbon layer having a relatively lower porosity. Therefore, the membrane electrode assembly maintains good ion conductivity in the polymer electrolyte membrane by suppressing the movement of water molecules from the polymer electrolyte membrane to the cathode electrode using a water pressure between two carbon layers having different porosity. Also, a flooding phenomenon in the cathode electrode is prevented, thereby maintaining the smooth movement of the oxidizing agent in the cathode.

### CROSS-REFERENCE TO RELATED APPLICATION

This application claims the benefit of Korean Application No. 2007-7902, filed Jun. 13, 2007, in the Korean Intellectual Property Office, the disclosure of which is incorporated herein by reference.

### BACKGROUND OF THE INVENTION

1. Field of the Invention

Aspects of the present invention relate to a membrane electrode assembly with a multilayered cathode electrode for a fuel cell system capable of improving a power generation efficiency by maintaining good ion conductivity while preventing water in a polymer electrolyte membrane from moving toward a cathode electrode.

2. Description of the Related Art

Generally, a fuel cell system is a power generation system that generates electricity through an oxidation reaction of hydrogen and a reduction reaction of an oxidizing agent. Basically, this fuel cell system includes a unit fuel cell having an electricity generation unit in which an electrochemical reaction of an oxidizing agent with hydrogen occurs. The unit fuel cell includes a polymer electrolyte membrane 2 having a good ion conductivity; an anode electrode 4 in which hydrogen is dissociated into a hydrogen ion (H⁺) and electrons by an active reaction of a catalyst with the hydrogen; and a cathode electrode 4 that generates water through a reaction of the oxidizing agent ion generated in the reduction process with hydrogen ions that move through the polymer electrolyte membrane 2, as shown in FIG. 1.

In the conventional fuel cell system, the polymer electrolyte membrane serves as a separator for blocking a mechanical contact of a cathode electrode with an anode electrode, as well as an ion conductor for the movement of hydrogen ions from the anode electrode to the cathode electrode. A polymer electrolyte such as a highly fluorinated sulfonate polymer wherein the highly fluorinated sulfonate polymer has a main chain composed of fluoroalkylene; and a side chain composed of fluorovinyl ether having a sulfonic acid group in its terminus (such as, for example, NAFION from t DuPont) has generally been used as the material of the polymer electrolyte membrane. The polymer electrolyte should contain a suitable amount of water in order to provide good ion conductivity.

Referring to FIG. 1 again, in the polymer electrolyte membrane 2, the hydrogen ions move from the anode electrode 4 to the cathode electrode 6. In this movement of the hydrogen ions, water molecules that are present in the polymer electrolyte membrane 2 also move to the cathode electrode 6 by means of the electro osmotic drag (EOD). Meanwhile, the water generated in the cathode electrode 6 through the above-mentioned reduction reaction moves to the polymer electrolyte membrane 2 by a concentration gradient.

The movement of the water molecules by the above-mentioned electro osmotic drag is increased in proportion to increasing current density, whereas the movement of water by the concentration gradient is in inverse proportion to the membrane thickness regardless of the current density. Accordingly, the movement of water molecules by electro osmotic drag is relatively active if the power generation capacity in the unit fuel cell is increased. In this case, the anode electrode of the polymer electrolyte membrane 2 becomes dry, while an excessive amount of water accumulates in the cathode electrode. As a result, the ion conductivity is slowed in the anode electrode of the polymer electrolyte membrane 2, and the oxidizing agent is prevented from smoothly moving in the cathode electrode due to a flooding phenomenon by the excessive amount of water.

### SUMMARY OF THE INVENTION

Accordingly, aspects of the present invention provide a membrane electrode assembly with a multilayered cathode electrode for a fuel cell system capable of improving material balance characteristics while maintaining ion conductivity by suppressing the movement of some water molecules using water pressure so that the smooth movement of the oxidizing agent can be maintained while maintaining good ion conductivity in the polymer electrolyte membrane even when the power generation capacity is increased in the unit fuel cell.

Also, aspects of the present invention provide a membrane electrode assembly with multilayered cathode electrode for a fuel cell system capable of preventing a flooding phenomenon in the cathode electrode by providing carbon layers arranged in the cathode electrode having different porosity such that hydrated ions, which are generated in the catalyst layer and passed through one carbon layer, may be easily left by the electro osmotic drag, and improving a power generation efficiency of the fuel cell system by maintaining the smooth movement of the oxidizing agent.

According to an embodiment of the present invention, there is provided a multilayered cathode electrode of a membrane electrode assembly of a fuel cell system, comprising a support layer; a catalyst layer; and multiple carbon layers interposed between the support layer and the catalyst layer and arranged according to a varying porosity.

According to an embodiment of the present invention, there is provided a multilayered cathode electrode of a membrane electrode assembly of a fuel cell system, comprising a support layer; a catalyst layer; and a first carbon layer and a second carbon layer interposed between the support layer and the catalyst layer, the first carbon layer having a relatively higher porosity and the second carbon layer having a relatively lower porosity.

According to another embodiment of the present invention, there is provided a membrane electrode assembly for a fuel cell system, comprising an anode electrode; a cathode electrode; and a polymer electrolyte membrane between the anode electrode and the cathode electrode, wherein the cathode electrode comprises a support layer; a catalyst layer; and a first carbon layer and a second carbon layer interposed between the support layer and the catalyst layer, the first carbon layer having a relatively higher porosity and the second carbon layer having a relatively lower porosity.

According to an aspect of the present invention, the first carbon layer may be adjacent to the catalyst layer, and the second carbon layer may be adjacent to the support layer. The second carbon layer may have a mean porosity of 80 to 85%, compared to that of the first carbon layer.

According to an aspect of the present invention, the carbon layer may contain PTFE, a PTFE content of the first carbon layer may be in the range of 40 to 50%, and a mean PTFE content of the second carbon layer may be in the range of 15 to 25%.

According to an aspect of the present invention, the anode electrode may comprise a support layer, a carbon layer and a catalyst layer.

According to an aspect of the present invention, the polymer electrolyte membrane may contain water that promotes ion conductivity through the polymer electrolyte membrane, and an aqueous methanol solution may be supplied to the anode electrode.

According to another embodiment of the present invention, there is provided a fuel cell comprising a membrane electrode assembly comprising an anode electrode; a cathode electrode; and a polymer electrolyte membrane between the anode electrode and the cathode electrode, wherein the cathode electrode comprises a support layer; a catalyst layer; and a first carbon layer and a second carbon layer interposed between the support layer and the catalyst layer, the first carbon layer having a relatively higher porosity and the second carbon layer having a relatively lower porosity; a first separator including a fuel supply channel to provide a hydrogen-containing fuel to the anode electrode; and a second separator including an oxidizing agent supply channel to provide an oxidizing agent to the cathode electrode.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a diagram illustrating a water transfer mechanism in a polymer electrolyte membrane of a membrane electrode assembly;

FIG. 2 is a cross-sectional view showing a configuration of a membrane electrode assembly in a unit fuel cell according to an embodiment of the present invention; and

FIG. 3 is a block view showing a fuel cell system having a membrane electrode assembly according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. Herein, when it is stated that one element is connected to another element, the one element may be directly connected to the other element or may be indirectly connected to the other element via a third element. Further, irrelevant elements are omitted for clarity.

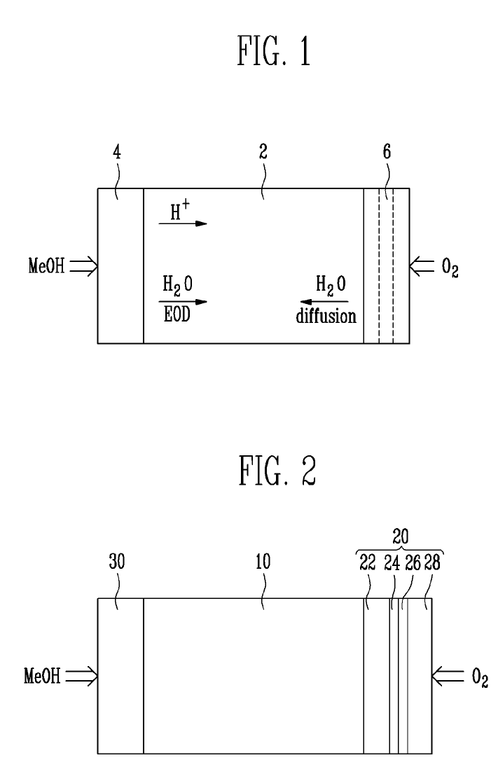

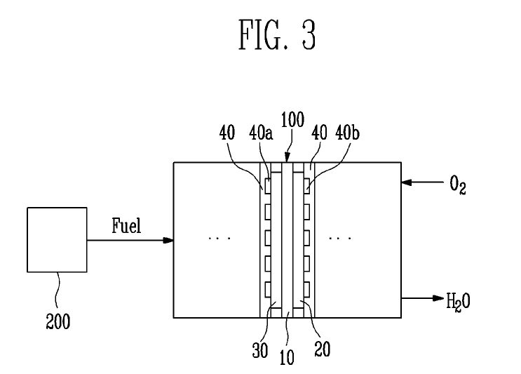

FIG. 2 is a cross-sectional view showing a configuration of a membrane electrode assembly in a unit fuel cell according to an embodiment of the present invention; and FIG. 3 is a block view showing a fuel cell system having a membrane electrode assembly according to an embodiment of the present invention.

Referring to FIG. 3, the fuel cell system includes an electricity generation unit 100 that generates electricity through an electrochemical reaction of oxygen with hydrogen; a fuel supply unit 200 that supplies a hydrogen-containing fuel to the electricity generation unit 100; and an oxidizing agent supply unit (not shown) that supplies an oxidizing agent to the electricity generation unit 100.

Hydrocarbon-based fuels such as ethanol, methanol and natural gas are used as the hydrogen-containing fuel, and oxygen, oxygen-containing fuels or air is generally used as the oxidizing agent.

The fuel supply unit 200 comprises a fuel storage unit (not shown) that stores a hydrogen-containing fuel; and a mixing unit (not shown) that supplies a hydrogen-containing fuel to the electricity generation unit 100, wherein the hydrogen-containing fuel is present at a predetermined concentration and formed by mixing the hydrogen-containing fuel, supplied from the fuel storage unit, with water, etc. Water and unreacted fuels discharged from the electricity generation unit 100 may be recovered and returned to the mixing unit described above, but detailed descriptions of the water and the untreated fuel are omitted herein.

The electricity generation unit 100 is provided with a unit fuel cell including a membrane electrode assembly (MEA) which is composed of a polymer electrolyte membrane 10 having selective ion permeability; an anode electrode 30 and a cathode electrode 20 provided respectively in opposite sides of the polymer electrolyte membrane 10. The unit fuel cell includes a separators 40 that supply a hydrogen-containing fuel and an oxidizing agent to the anode electrode 30 and the cathode electrode 20, respectively. In the separators 40, the hydrogen-containing fuel and the oxidizing agent are supplied to the anode electrode 30 and the cathode electrode 20 through a fuel supply channel 40a and an oxidizing agent supply channel 40b, respectively. At this time, the electricity generation unit 100 has a structure in which a plurality of unit fuel cells are stacked. In such as case, each separator 40 may be a bipolar plate having a fuel supply channel 40a on one side of the plate and an oxidizing agent supply channel 40b on the other side of the bipolar plate.

Referring to FIG. 2, in the membrane electrode assembly, the polymer electrolyte membrane 10 is a conductive polymer electrolyte membrane that prevents the transmission of a hydrogen-containing fuel through the membrane and supplies a hydrogen ion to the catalyst layer 22 of the cathode electrode 20, the hydrogen ion being generated in a catalyst layer (not shown) of the anode electrode 30. The polymer electrolyte membrane 10 has a thickness of approximately 50˜200 μm. A perfluorinated hydrofluoric acid resin film made of perfluorosulfonate resin (NAFION), a film in which a porous polytetrafluoroethylene thin film support is coated with a resin solution, a film in which a porous non-conductive polymer support is coated with cation exchange resin and inorganic silicate, etc. may be used, for example, as the polymer electrolyte membrane 10.

The anode electrode 30 comprises a porous support layer such as carbon paper, and a carbon layer and a catalyst layer, which are catalyst materials sequentially laminated onto the porous support layer. Generally, the carbon layer is referred to as a microporous layer (MPL), and the carbon layer and the support layer are referred to as a diffusion layer. The porous support layer provides an efflux path for carbon dioxide (CO₂), which is a by-product in an electrochemical reaction that occurs in the catalyst layer as described later, as well as an influx path for a hydrogen-containing fuel supplied through a fuel supply channel 40a (see FIG. 3) formed in a surface of one of the separators 40. In the catalyst layer, a predetermined concentration of the hydrogen-containing fuel, such as, for example, methanol that is supplied via the porous support layer and the carbon layer, reacts to form hydrogen ions through the oxidation reaction represented by the following equation 2.

Anode reaction: CH₃OH+H₂O→CO₂+6H⁺+6e⁻ Equation 2

The carbon layer is interposed between the porous support layer and the catalyst layer to serve to uniformly distribute the hydrogen-containing fuel, supplied through the fuel supply channel 40a, over the catalyst layer, and also to serve to discharge carbon dioxide, generated through the oxidation reaction, into the porous support layer. Hydrogen-containing fuel that does not participate in the above-mentioned oxidation reaction of the anode electrode fuel may be recovered and re-used as unreacted fuel.

According to aspects of the present invention, the cathode electrode 20 comprises a porous support layer 28 such as carbon paper, carbon layers 24, 26 and a catalyst layer 22, which are catalyst materials sequentially laminated onto the porous support layer 28. The porous support layer 28 provides an efflux path of water (H₂O) which is a by-product in the electrochemical reaction that occurs in the catalyst layer as described later, as well as an influx path of an oxidizing agent, such as, for example oxygen, supplied through the oxidizing agent supply channel 40b (see FIG. 3) formed in a surface of the other one of the separators 40. In the catalyst layer 22, the oxygen supplied via the porous support layer 28 and the carbon layers 24, 26 reacts with hydrogen ions and electrons to form water through the reduction reaction represented by the following equation 1.

Cathode Reaction: (3/2)O₂+6H⁺+6e⁻→3H₂O Equation 1

The carbon layers 24, 26 are interposed between the porous support layer 28 and the catalyst layer 22 to serve to uniformly distribute the oxygen, supplied through the oxidizing agent supply channel 40b, over the catalyst layer 22, and also to serve to discharge the water, generated through the reduction reaction, into the porous support layer 28.

The carbon layers 24, 26 of the cathode electrode 20 may be classified according to the porosity. That is to say, a carbon layer having a relatively small porosity, namely the second carbon layer 24, is arranged adjacent to the catalyst layer 22, and a carbon layer having a relatively large porosity, namely the first carbon layer 26, is arranged adjacent to the porous support layer 28.

A mean porosity of the second carbon layer 24 ranges from approximately 70 to 95%, or, as a more specific, non-limiting example, from approximately 80 to 85%, based on the mean porosity of the first carbon layer 26. The carbon layers 24, 26 contain PTFE. The PTFE content of the first carbon layer ranges from 40 to 50%, and the mean PTFE content of the second carbon layer ranges from 15 to 25%. The porosity of the carbon layers 24, 26 may be measured using a porosimetry apparatus by increasing % values of PTFE on the basis of 0% PTFC GDL, and then the resultant value may be used as a reference value.

As described above, the carbon layer comprises the first carbon layer 26 and the second carbon layer 24, which differ in porosity. Therefore, clogging of the path of an oxidizing agent, such as, for example, oxygen, by a flooding phenomenon caused by water molecules transferring through the electrolyte membrane is prevented, since the transfer of the water molecules is effectively interrupted by the second carbon layer 24 having a low porosity. As a result, the oxygen, supplied through the porous support layer 28, smoothly flows in through the first carbon layer 26 having a relatively large porosity, and then is uniformly distributed over the catalyst layer 22 via the second carbon layer 24.

Also, a power generation efficiency of the fuel cell system may be improved by the first carbon layer 26 having a large porosity by preventing some of other hydrated ions that pass through the first carbon layer 26 due to the electro osmotic drag from causing a flooding phenomenon in the cathode electrode and by maintaining the smooth transfer of the oxidizing agent.

Accordingly, if a predetermined concentration of the hydrogen-containing fuel, such as, for example, an aqueous methanol solution, is supplied from the fuel supply unit 200 to the anode electrode 30 of the electricity generation unit 100, and the oxidizing agent, namely oxygen, is also supplied from the oxidizing agent supply unit to the cathode electrode 20 of the electricity generation unit 100, then carbon dioxide, hydrogen ions and electrons are generated in the anode electrode 30 through the reaction of water with methanol (see Equation 1). The hydrogen ions are supplied to the cathode electrode 20 through the polymer electrolyte membrane 10, such as, for example a hydrogen ion exchange membrane. The hydrogen ions and the electrons react with oxygen ions in the cathode electrode 20 to generate water (see Equation 2). Taken as a whole, methanol reacts with oxygen to generate electricity while generating water and carbon dioxide.

When the hydrogen ions are transferred from the anode electrode 30 to the cathode electrode 20 through the polymer electrolyte membrane 10, water molecules that accompany the hydrogen ions are intercepted by the second carbon layer 24 constituting the cathode electrode 20. As a result, a wet condition in the polymer electrolyte membrane 10 is desirably maintained, and therefore, the ion conductivity is also desirably maintained. Also, a flooding phenomenon in the cathode electrode may be prevented such that the oxidizing agent from the oxidizing agent supply unit can be smoothly transferred to the catalyst layer 22 since the transfer of the water molecules is inhibited by the electro osmotic drag.

As described above, the membrane electrode assembly according to aspects of the present invention may be useful to maintain good ion conductivity in the polymer electrolyte membrane by laminating multiple carbon layers of the cathode electrode according to their porosity to suppress water molecules from moving from the polymer electrolyte membrane to the cathode electrode due to the electro osmotic drag, and also to improve a power generation efficiency of the fuel cell system by preventing flooding in the cathode electrode, thereby maintaining the smooth movement of the oxidizing agent.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A multilayered cathode electrode of a membrane electrode assembly of a fuel cell system, comprising:
a support layer;
a catalyst layer; and
multiple carbon layers interposed between the support layer and the catalyst layer and arranged according to a varying porosity.

2. The multilayered cathode electrode of claim 2, wherein the multiple carbon layers are arranged in an order of increasing porosity from the catalyst layer to the support layer.

3. A multilayered cathode electrode of a membrane electrode assembly of a fuel cell system, comprising:
a support layer;
a catalyst layer; and
a first carbon layer and a second carbon layer interposed between the support layer and the catalyst layer, the second carbon layer having a lower porosity than that of the first carbon layer.

4. The multilayered cathode electrode according to claim 3, wherein the first carbon layer is adjacent to the support layer, the second carbon layer is adjacent to the catalyst layer.

5. The multilayered cathode electrode according to claim 4, wherein the porosity of the second carbon layer is 80 to 85% of the porosity of the first carbon layer.

6. The multilayered cathode electrode according to claim 5, wherein the first carbon layer and the second carbon layer contain polytetrafluoroethylene (PTFE), wherein the PTFE content in the first carbon layer is in the range of 40 to 50% and the PTFE content in the second carbon layer is in the range of 15 to 25%.

7. A membrane electrode assembly for a fuel cell system, comprising
an anode electrode;
a cathode electrode; and
a polymer electrolyte membrane between the anode electrode and the cathode electrode,
wherein the cathode electrode comprises:
a support layer;
a catalyst layer; and
a first carbon layer and a second carbon layer interposed between the support layer and the catalyst layer, the second carbon layer having a lower porosity than that of the first carbon layer.

8. The membrane electrode assembly according to claim 7, wherein the first carbon layer is adjacent to the support layer, the second carbon layer is adjacent to the catalyst layer.

9. The membrane electrode assembly according to claim 8, wherein the porosity of the second carbon layer is 80 to 85% of the porosity of the first carbon layer.

10. The membrane electrode assembly according to claim 9, wherein the first carbon layer and the second carbon layer contain polytetrafluoroethylene (PTFE), wherein the PTFE content in the first carbon layer is in the range of 40 to 50% and the PTFE content in the second carbon layer is in the range of 15 to 25%.

11. The membrane electrode assembly according to claim 7, wherein the anode electrode comprises a support layer, a carbon layer and a catalyst layer.

12. The membrane electrode assembly according to claim 7, wherein the polymer electrolyte membrane contains water that promotes ion conductivity through the polymer electrolyte membrane.

13. The membrane electrode assembly according to claim 8, wherein an aqueous methanol solution is supplied to the anode electrode.

14. A fuel cell comprising:
a membrane electrode assembly comprising
an anode electrode;
a cathode electrode; and
a polymer electrolyte membrane between the anode electrode and the cathode electrode,
wherein the cathode electrode comprises:
a support layer;
a catalyst layer; and
a first carbon layer and a second carbon layer interposed between the support layer and the catalyst layer, the second carbon layer having a lower porosity than that of the first carbon layer;
a first separator including a fuel supply channel to provide a hydrogen-containing fuel to the anode electrode; and
a second separator including an oxidizing agent supply channel to provide an oxidizing agent to the cathode electrode.

15. The fuel cell according to claim 14, wherein the first carbon layer is adjacent to the support layer, the second carbon layer is adjacent to the catalyst layer.

16. The fuel cell according to claim 15, wherein the porosity of the second carbon layer is 80 to 85% of the porosity of the first carbon layer.

17. The fuel cell according to claim 14, wherein the first carbon layer and the second carbon layer contain polytetrafluoroethylene (PTFE), wherein the PTFE content in the first carbon layer is in the range of 40 to 50% and the PTFE content in the second carbon layer is in the range of 15 to 25%.

18. The fuel cell of claim 15, wherein the fuel cell uses aqueous methanol as the hydrogen-containing fuel to generate hydrogen ions, wherein some of the water in the aqueous methanol travels with the hydrogen ions through the polymer electrolyte membrane from the anode electrode toward the cathode electrode by electro osmotic drag and wherein the second carbon layer having the relatively lower porosity controls a humidity of the polymer electrolyte membrane by controlling a rate at which the water passes from the polymer electrolyte membrane to the cathode electrode.

19. The fuel cell of claim 18, wherein water is generated in the cathode electrode and wherein the first carbon layer having the relatively higher porosity prevents a flooding of the cathode electrode by the generated water and by the water that passes from the polymer electrolyte membrane to the cathode electrode.
